(19) United States
(12) Patent Application Publication
(10) Pub. No.: US 2006/0119597 A1
(43) Pub. Date: Jun. 8, 2006

(54) Image forming apparatus and method

(76) Inventor: Takahiro Oshino, Tochigi-ken (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/288,015

(22) Filed: Nov. 28, 2005

(30) Foreign Application Priority Data
Dec. 3, 2004 (JP) 2004-351509

(51) Int. Cl. G06T 1/00; G06F 17/00

(52) U.S. Cl. 345/418

(57) ABSTRACT

An image forming apparatus stores videos imaged by plural imaging units from plural positions different from one another in a memory. When a desired position and a desired imaging time are designated, plural frame images with at least positions or imaging times different from one another are acquired on the basis of the desired position and the desired imaging time designated. An image is formed by synthesizing the plural frame images acquired such that that plural frame images can be sequentially observed as stereoscopic images in accordance with movement of an observation view position when the plural frame images are observed via a predetermined optical system.

### FIELD OF THE INVENTION

The present invention relates to a method and an apparatus for forming an image, for which stereoscopic observation is possible via a multi-view type observation optical system, from videos obtained by plural imaging means.

### BACKGROUND OF THE INVENTION

Conventionally, various systems have been developed as methods of displaying stereoscopic images. Among the methods, a stereoscopic display method using binocular parallax for presenting images with parallax to both left and right eyes to cause an observer to perform stereoscopic viewing is widely used. In recent years, a large number of multi-view type stereoscopic image display systems for widening a visual field to realize smooth motion parallax have been studied. In the multi-view type stereoscopic image display systems, images acquired or generated in a large number of view positions are used to create a multi-view composite image (hereinafter referred to as composite image) obtained by rearranging a pixel arrangement of the images into a pixel arrangement corresponding to a specific optical system. It is possible to sense the composite image as a stereoscopic image by observing the composite image via the specific optical system. Rearrangement of a pixel arrangement in the case in which a lenticular board is used as the specific optical system is explained with reference to FIGS. 25 and 26.

In FIG. 25, a state in which images for a multi-view type stereoscopic display system are acquired using four cameras is schematically shown. It is assumed that four cameras 2500 to 2503 are aligned at predetermined intervals (base line lengths) on a base line 2504 such that optical centers of the cameras are parallel to one another. Two-dimensional images acquired in respective camera positions are used to generate a composite image of a pixel arrangement that can be stereoscopically viewed when observed via a lenticular board shown in FIG. 26.

When a pixel value of a jth view position is Pⱼₘₙ (m and n are indexes of pixel arrangements in horizontal and vertical directions, respectively), jth image data is represented as two-dimensional arrangements as indicated below.

Pⱼ₁₁ Pⱼ₂₁ Pⱼ₃₁ . . .

Pⱼ₁₂ Pⱼ₂₂ Pⱼ₃₂ . . .

Pⱼ₁₃ Pⱼ₂₃ Pⱼ₃₃ . . .

Since the lenticular board is considered as an optical system for performing observation, image arrangements for synthesizing an image are image arrangements obtained by decomposing images of respective view positions in a strip shape for each line in a vertical direction and rearranging the images equivalent to the number of view positions in an inverse order of view positions. Therefore, a multi-view composite image is a stripe-like image indicated below.

P₄₁₁ P₃₁₁ P₂₁₁ P₁₁₁ P₄₂₁ P₃₂₁ P₂₂₁ P₁₂₁ P₄₃₁ P₃₃₁ P₂₃₁ P₁₃₁ . . .

P₄₁₂ P₃₁₂ P₂₁₂ P₁₁₂ P₄₂₂ P₃₂₂ P₂₂₂ P₁₂₂ P₄₃₂ P₃₃₂ P₂₃₂ P₁₃₂ . . .

P₄₁₃ P₃₁₃ P₂₁₃ P₁₁₃ P₄₂₃ P₃₂₃ P₂₂₃ P₁₂₃ P₄₃₃ P₃₃₃ P₂₃₃ P₁₃₃ . . .

Note that a view position of j=1 represents an image at a left end ((1) in FIG. 25) and a view position of j=4 represents an image at a right end ((4) in FIG. 25). The view positions are rearranged in an inverse order of an arrangement of the cameras because, in observing an image with the lenticular board, the image is observed with the left and the right thereof reversed in one pitch of lenticular. It is possible to observe a stereoscopic image by observing the composite image, which is created by rearranging the images, via the lenticular board as shown in FIG. 26.

As a multi-view type stereoscopic display system different from the one described above, a stereoscopic display apparatus described in Japanese Patent Application Laid-Open No. 2004-007566 of the applicant is briefly explained. The stereoscopic display apparatus is a multi-view type stereoscopic display apparatus in which deviation of display light, so-called crosstalk, does not occur in an observation position. As shown in FIG. 27, a display 2700 serving as an image display unit, a lateral lenticular lens 2701 arranged on a front surface of the display 2700, and a mask 2702 arranged on a front surface of the lateral lenticular lens 2701 are arranged in this order from the display 2700 to observation positions 2703.

FIG. 28 shows how pixels of an original image are displayed in respective pixels of the display 2700 when the number of view positions is set to nine. As a method of arranging the pixels, pixels from D1 to D9 corresponding to the nine view positions are cyclically arranged repeatedly in this order in respective horizontal rows of the pixels (hereinafter referred to as pixel horizontal rows). Horizontal direction positions of the pixels from D1 to D9 are shifted by three pixels every time a pixel horizontal column differs by one column in the vertical direction and the same pixel arrangement is obtained every time the pixel horizontal column differs by three columns in the vertical direction. Consequently, as indicated by a dotted line 2801 in FIG. 28, a pixel block in which the nine pixels from D1 to D9 are arranged in a matrix shape of 3 (rows)×3 (columns) is formed. A display image 2800 with the pixel block arranged in plural forms in the vertical and the horizontal directions is formed.

Nine images corresponding to the nine view positions are displayed using respective pixels in each of the plural pixel blocks (i.e., respective pixel groups of D1 to D9). A display image created in this way is displayed on the display 2700. Luminous fluxes of the pixels reach the observation positions 2703 via the lateral lenticular lens 2701 and the mask 2702 arranged on a front surface of the display 2700. Consequently, only the luminous fluxes from the respective pixels corresponding to the nine view positions reach the observation positions 2703. The observation positions 2703 from E1 to E9 are repeatedly formed in the horizontal direction to make it possible to perform stereoscopic image display of the nine view positions. In a color display in which one pixel is formed by sub-pixels of three colors R, G, and B, it is also possible to constitute a stereoscopic display apparatus that does not cause color separation on an observation surface by changing a pixel arrangement displayed on the display 2700 and constitutions of the lateral lenticular 2701 and the mask 2702.

On the other hand, there is a stereoscopic image printing system disclosed in Japanese Patent Application Laid-open No. 2001-346226 proposed by the applicant as a stereoscopic image printing system. In the stereoscopic image printing system in the proposal, a stereo adapter is amounted on a camera to input a stereo image and the stereo image is processed to generate a multi-view composite image having a pixel arrangement corresponding to a predetermined optical system. The stereoscopic image printing system makes it possible to print a stereoscopic image easily by printing the composite image. It is possible to observe a stereoscopic image by observing a result of the printing via the predetermined optical system. Note that, in the processing for the stereo image, corresponding point extraction is performed from the stereo image, a parallax map representing depth is created from a result of the corresponding point extraction, and forward mapping is performed using the parallax map created to thereby create a new view position two-dimensional image in a position not imaged. As explained above, the stereoscopic display apparatus and the stereoscopic image printing system are present.

On the other hand, a system for printing a stereoscopic video having motion is proposed in Japanese Patent Application Laid-open No. 09-146045. In the proposal, it is possible to observe a stereoscopic image like a moving picture by recording images at respective times and in respective positions of a stereoscopic image on a lenticular board, a polarizing plate, and an image sheet corresponding to the polarizing plate and observing the images via polarized glasses.

However, in Japanese Patent Application Laid-open No. 09-146045, the images at the respective times in the stereoscopic video are simply extracted to directly create the image sheet. Therefore, a user cannot stereoscopically print an attractive stereoscopic video that uses a large number of kinds of information held by the stereoscopic video itself.

### SUMMARY OF THE INVENTION

In view of the problems described above, it is an object of the invention to make it possible to easily execute stereoscopic print using various kinds of information held by a stereoscopic video.

In order to achieve the above object, according to one aspect of the present invention, there is provided an image forming apparatus comprising: a storing unit configured to store videos imaged by plural imaging units from plural positions different from one another; a designating unit configured to designate a desired position and a desired imaging time; an acquiring unit configured to acquire plural frame images with at least positions or imaging times different from one another on the basis of the desired position and the desired imaging time designated by the designating unit and the videos stored in the storing unit; and a forming unit configured to form an image by synthesizing the plural frame images acquired by the acquiring unit such that that plural frame images can be sequentially observed as stereoscopic images in accordance with movement of an observation view position when the plural frame images are observed via a predetermined optical system.

Furthermore, according to another aspect of the present invention, there is provided an image forming apparatus comprising: a designating unit configured to designate a desired view position and a desired time; a selecting unit configured to select plural view positions and times on the basis of the desired view position and the desired time designated by the designating unit; an acquiring unit configured to render frame images of the computer graphics video corresponding to the plural view position and times selected by the selecting unit, and acquire plural frame images; and a forming unit configured to form an image by synthesizing the plural frame images acquired by the acquiring unit such that the plural frame images can be sequentially observed as stereoscopic images in accordance with movement of an observation view position when the plural frame images are observed via a predetermined observation optical system.

According to the invention, an image forming method using the image forming apparatus, a control program for executing the image forming method using a computer, and a storage medium having the control program stored therein are provided.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing a logical constitution of a stereoscopic image forming apparatus according to a first embodiment of the invention;

FIG. 2 is a diagram showing a physical constitution of the stereoscopic image forming apparatus according to the first embodiment;

FIG. 3 is a main flowchart of processing according to the first embodiment;

FIG. 4 is a flowchart concerning stereoscopic display according to the first embodiment;

FIG. 5 is a flowchart concerning parameter setting for stereoscopic video printing according to the first embodiment;

FIG. 6 is a flowchart concerning stereoscopic video printing according to the first embodiment;

FIG. 7 is a diagram showing an example of a GUI for video selection according to the first embodiment;

FIGS. 8A to 8D are diagrams showing an example of a GUI for video selection according to the first embodiment;

FIG. 9 is a diagram showing an example of a GUI for video selection according to the first embodiment;

FIG. 10 is a diagram showing an example of a GUI for video selection according to the first embodiment;

FIG. 11 is a diagram showing an example of a GUI for stereoscopic printing apparatus selection according to the first embodiment;

FIG. 12 is a diagram showing an example of a GUI for stereoscopic printing apparatus selection according to the first embodiment;

FIG. 13 is a diagram for explaining pixel arrangement of a composite image in a stereoscopic display apparatus;

FIG. 14A is a diagram for explaining pixel arrangement of a composite image in a stereoscopic printing apparatus;

FIG. 14B is a diagram for explaining an observation form of stereoscopic print;

FIG. 15 is a diagram for explaining pixel arrangement of a composite image in a stereoscopic display apparatus in the case in which preview of a result of stereoscopic print is performed using the stereoscopic display apparatus;

FIG. 16 is a diagram for schematically explaining stereoscopic video input and a imaging object;

FIG. 17 is a diagram for explaining stereoscopic video selection and a stereoscopic printing effect;

FIGS. 18A to 18E are diagrams for explaining automatic selection of a stereoscopic video;

FIG. 19 is a diagram showing a logical constitution of a stereoscopic image forming apparatus according to a second embodiment of the invention;

FIG. 20 is a main flowchart of processing according to the second embodiment;

FIG. 21 is a flowchart concerning stereoscopic display according to the second embodiment;

FIG. 22 is a flowchart concerning parameter setting for stereoscopic video printing according to the second embodiment;

FIG. 23 is a flowchart concerning stereoscopic video printing according to the second embodiment;

FIG. 24 is a diagram for explaining a relation among a three-dimensional scene, a virtual camera, and a three-dimensional object;

FIG. 25 is a schematic diagram for explaining conventional imaging of a multi-view stereoscopic image;

FIG. 26 is a schematic diagram in the case in which a lenticular board is used as a conventional multi-view type stereoscopic display system;

FIG. 27 is a diagram showing an example of a constitution in a stereoscopic display apparatus described in Japanese Patent Application Laid-open No. 2004-007566 proposed by the applicant; and

FIG. 28 is a diagram showing pixel arrangement in the stereoscopic display apparatus described in Japanese Patent Application Laid-open No. 2004-007566 proposed by the applicant.

### DETAILED DESCRIPTION OF THE PREFERRED EMBODIMENTS

Preferred embodiments of the present invention will now be described in detail in accordance with the accompanying drawings.

### First Embodiment

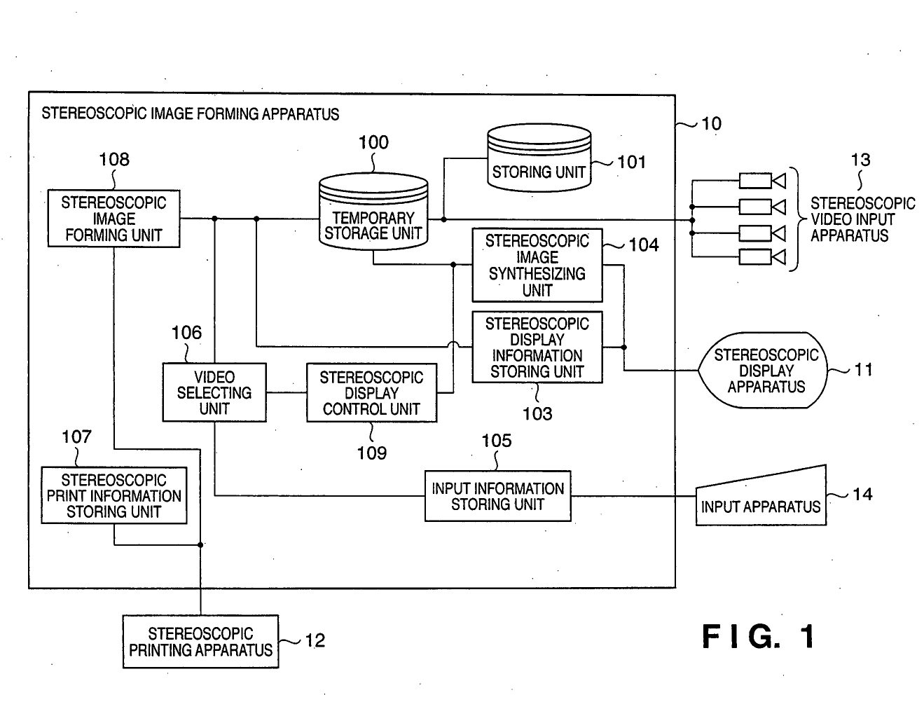

FIG. 1 is a block diagram showing a functional constitution of a stereoscopic video printing system using a stereoscopic image forming apparatus according to a first embodiment of the invention.

A stereoscopic image forming apparatus 10 forms a composite image for displaying a stereoscopic video, which is imaged in plural different view positions, with a stereoscopic display apparatus 11 and printing the stereoscopic video with a stereoscopic printing apparatus 12. A stereoscopic video input apparatus 13 inputs moving images from plural cameras that are arranged to be suitable for the stereoscopic display apparatus 11 (a stereoscopic video is constituted by the plural moving images). The stereoscopic video acquired by the stereoscopic video input apparatus 13 is synthesized to be suitable for an optical system for stereoscopic view observation in the stereoscopic image forming apparatus 10 and stereoscopically displayed by the stereoscopic display apparatus 11. An input apparatus 14 inputs various kinds of setting from a user. The stereoscopic printing apparatus 12 prints the composite image synthesized by the stereoscopic image forming apparatus 10.

An internal block constitution of the stereoscopic image forming apparatus 10 is explained. A temporary storage unit 100 is a storage area for recording a stereoscopic video inputted from the stereoscopic video input apparatus 13 for a certain fixed interval. A stereoscopic video inputted in advance is saved as a file in a storing unit 101. Note that such a file may be compressed by a publicly-known compression technique (Multi View Profile of MPEG 2, etc.) and saved. A stereoscopic display information storing unit 103 is a storage area in which parameters peculiar to an apparatus concerning stereoscopic display of the stereoscopic display apparatus 11 are stored. A stereoscopic image synthesizing unit 104 generates a composite image corresponding to the stereoscopic display apparatus 11 from the stereoscopic video stored in the temporary storage unit 100 with reference to the parameters stored in the stereoscopic display information storing unit 103. An input information storing unit 105 is an area for storing various parameters inputted and set by a user such as time for specifying a video designated by the user that should be printed stereoscopically.

A video selecting unit 106 selects a frame in the stereoscopic video that should be printed stereoscopically from the stereoscopic video stored in the temporary storage unit 100 or the storing unit 101 according to input information stored in the input information storing unit 105. A stereoscopic print information storing unit 107 is an area in which parameters peculiar to an apparatus concerning stereoscopic print of the stereoscopic printing apparatus 12 are stored. A stereoscopic image forming unit 108 performs formation of a stereoscopic image on the basis of the frame in the stereoscopic video selected by the video selecting unit 106 and the stereoscopic print information stored in the stereoscopic print information storing unit 107. A stereoscopic display control unit 109 performs control for previewing a stereoscopic video, which is stereoscopically printed in the stereoscopic printing apparatus 12, in the stereoscopic display apparatus 11.

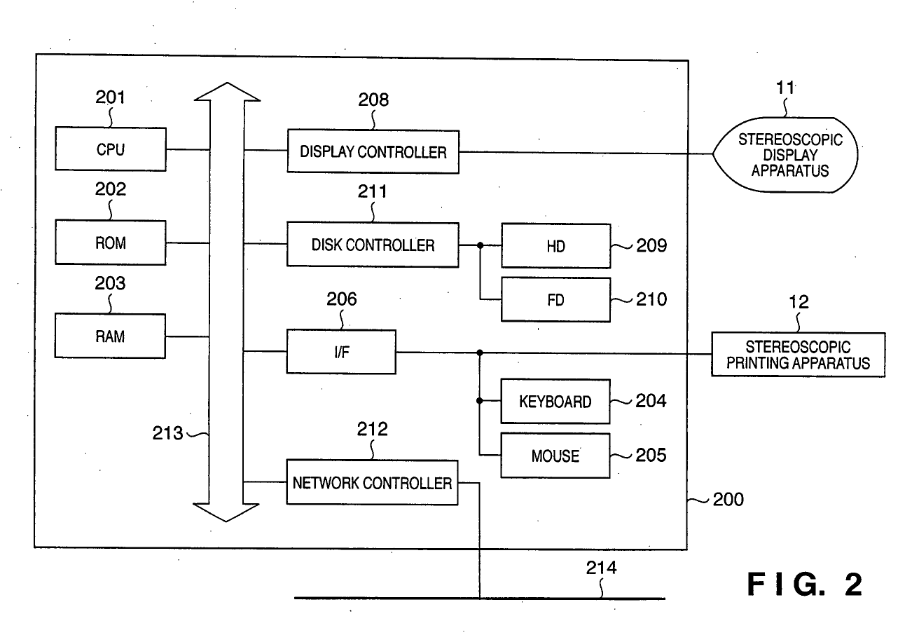

An example of a physical constitution of the stereoscopic image forming apparatus 10 in this embodiment is explained with reference to FIG. 2. The stereoscopic image forming apparatus 10 is constituted by, for example, a general-purpose personal computer 200. In the personal computer 200, a CPU 201, a ROM 202, a RAM 203, an interface (I/F) 206, a display controller 208, a disk controller 211, and a network controller 212 are connected to be capable of communicating with one another via a system bus 213. The system bus 213 is connected to a network 214 via a network controller 212. The stereoscopic display apparatus 11 is connected to the display controller 208. A keyboard 204, a mouse 205, and a stereoscopic printing apparatus 12 are connected to the interface 206. Moreover, a hard disk (HD) 209 and a flexible disk (FD) 210 are connected to the disk controller 211.

The CPU 201 collectively controls the respective components connected to the system bus 213 by executing software stored in the ROM 202 or the HD 209 or software supplied from the FD 210. In other words, the CPU 201 performs control for realizing respective functions in this embodiment by reading out predetermined processing programs from the ROM 202, the HD 209, or the FD 210 and executing the processing programs. The RAM 203 functions as a main storage or a work area of the CPU 201. The temporary storage unit 100, the storing unit 101, the input information storing unit 105, the stereoscopic display information storing unit 103, and the stereoscopic print information storing unit 107 in the stereoscopic image forming apparatus 10 are realized by the ROM 202, the HD 209, or the FD 210. Note that the storing units can also be realized by a constitution for acquiring data from an external storage via the network 214. Respective functions of the stereoscopic image synthesizing unit 104, the stereoscopic display control unit 109, the video selecting unit 106, and the stereoscopic image forming unit 108 are realized by the CPU 201 executing predetermined control programs. The input apparatus 14 is realized by the keyboard 204 and the mouse 205.

The display controller 208 is connected to the stereoscopic display apparatus 11. The display controller 208 transfers a composite image obtained by synthesizing a stereoscopic video in the stereoscopic image synthesizing unit 104 to the stereoscopic display apparatus 11 and causes the stereoscopic display apparatus 11 to perform stereoscopic display. The disk controller 211 controls accesses to the HD 209 and the FD 210 that store a boot program, various applications, an edition file, a user file, a network management program, the processing programs in this embodiment, and the like. The network controller 212 bilaterally exchanges data with apparatuses on the network 214. Through the operations of the respective units described above, it is possible to form a stereoscopic video to be printed in the stereoscopic printing apparatus 215. Note that the stereoscopic image forming apparatus 10 and the input apparatus 14 are connected using an interface such as a USB. The stereoscopic image forming apparatus 10 and the stereoscopic display apparatus 11 are connected via an interface for videos such as a DVI (Digital Visual Interface).

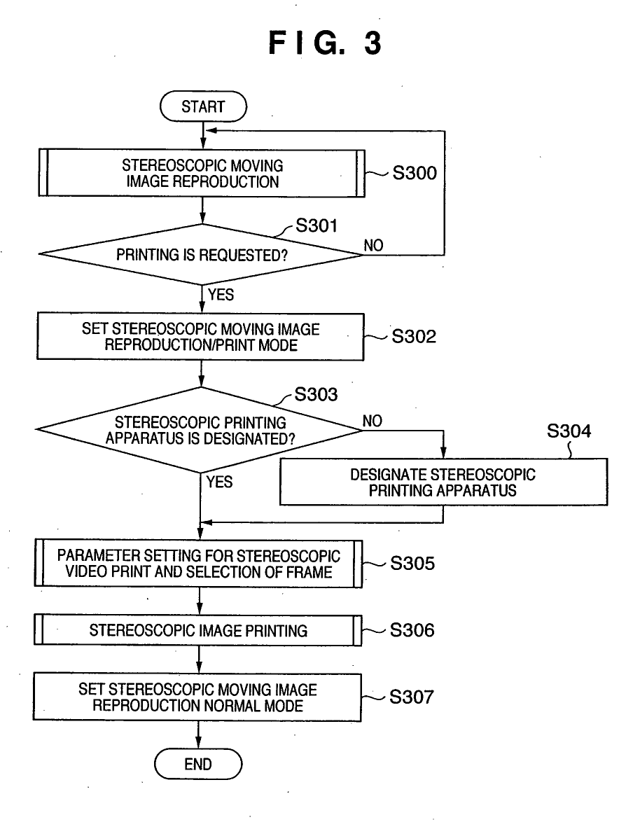

A flow of processing of the stereoscopic video printing system in this embodiment is explained in detail with reference to a flowchart in FIG. 3.

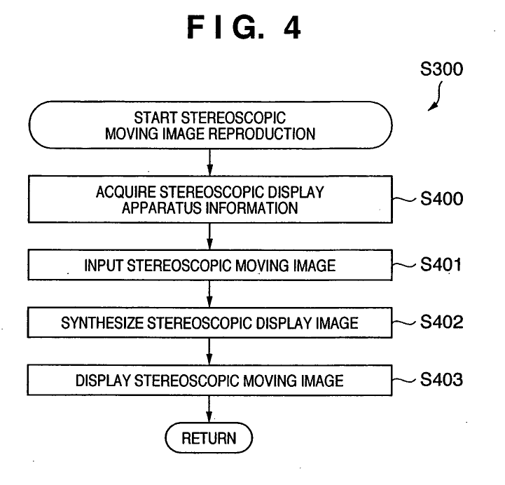

First, in step S300, the stereoscopic video printing system synthesizes a stereoscopic video (plural moving images) inputted from the stereoscopic video input apparatus 13 and displays the stereoscopic video on the stereoscopic display apparatus 11. Details of the processing are explained with reference to a flowchart in FIG. 4.

First, in step S400, the stereoscopic image synthesizing unit 104 acquires information on stereoscopic display parameters of the stereoscopic display apparatus 11. The stereoscopic display parameters acquired are stored in the stereoscopic display information storing unit 103 in FIG. 1. The stereoscopic display parameters include a pixel arrangement of a composite image due to an optical system peculiar to the stereoscopic display apparatus 11, a recommended observation distance, and maximum/minimum parallax amounts among images. Note that, in this embodiment, it is assumed that the respective cameras of the stereoscopic video input apparatus 13 are arranged in association with the stereoscopic display apparatus 11.

In step S401, the stereoscopic image synthesizing unit 104 starts input of a stereoscopic video from the stereoscopic video input apparatus 13 in FIG. 1. At this point, the stereoscopic image synthesizing unit 104 connects a synthesizing apparatus (not shown) for synthesizing moving image acquiring time and the stereoscopic video input apparatus 13 to acquire respective camera videos (i.e., plural moving images) in synchronization with one another. The stereoscopic image acquired in this way is stored in the temporary storage unit 100 in time series by a fixed amount, that is, by an amount equivalent to a predetermined period for each camera.

The storage of the fixed amount in the temporary storage unit 100 is realized by a storage operation of discarding a temporally old video and overwriting the video with a new one. Note that all or a part of stereoscopic videos obtained by the stereoscopic video input apparatus 13 may be recorded in the storing unit 101 as a stereoscopic video file.

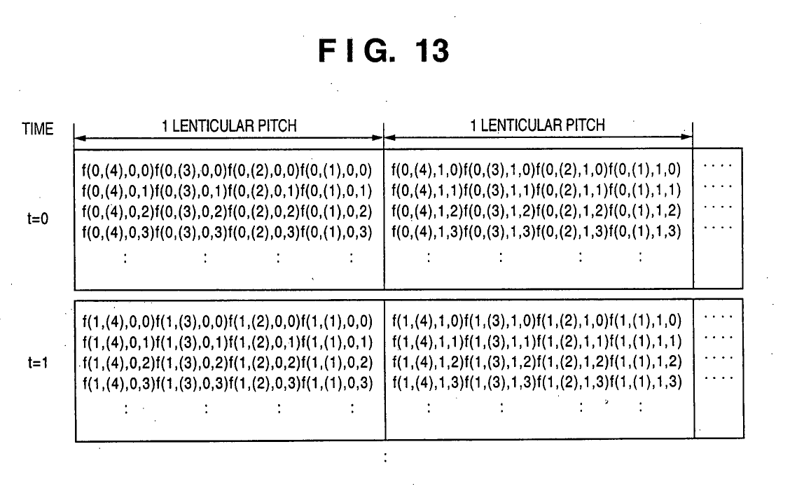

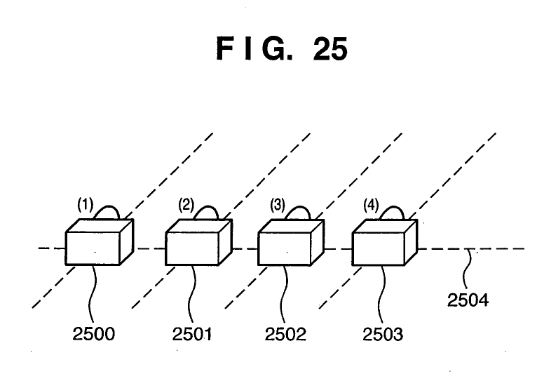

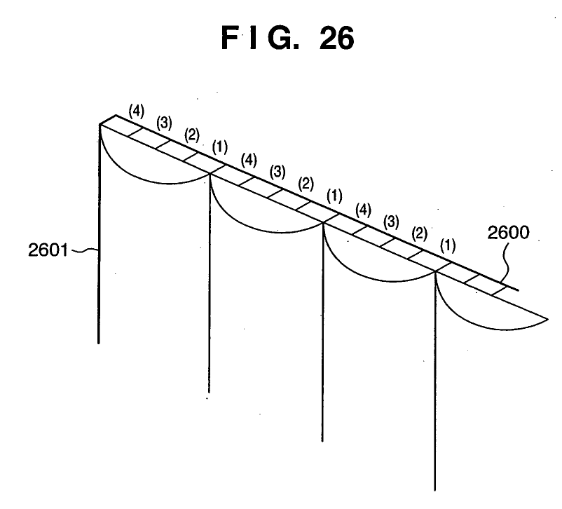

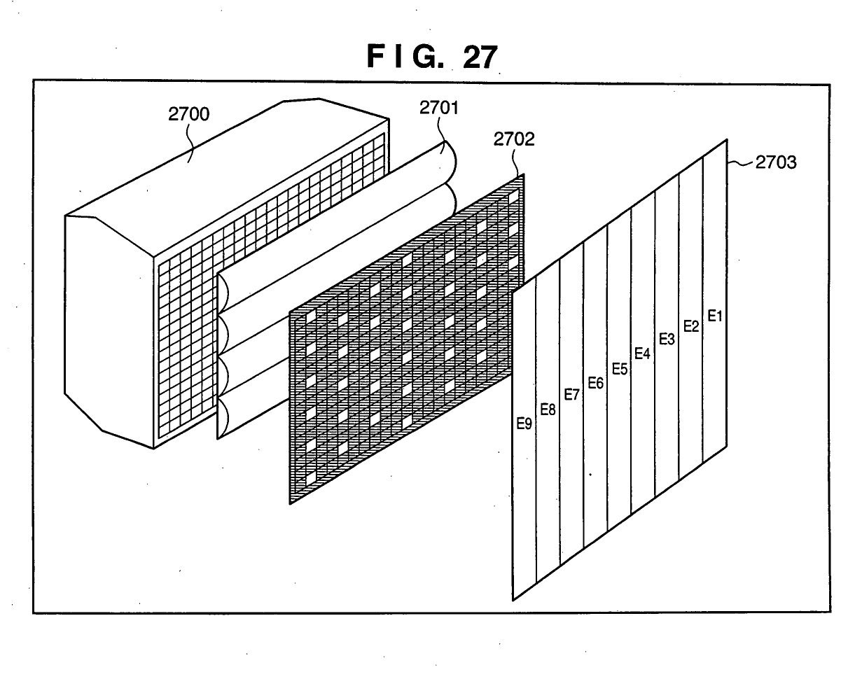

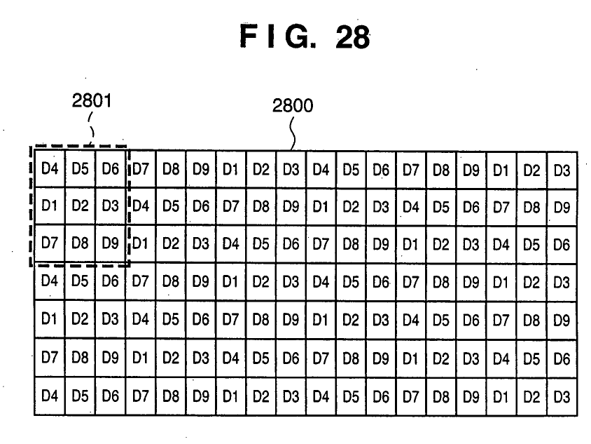

In step S402, the stereoscopic image synthesizing unit 104 rearranges the stereoscopic video inputted from the stereoscopic video input apparatus 13 into a pixel arrangement of the composite image of the stereoscopic display apparatus 11 to generate a composite image. Note that, at this point, in order to generate a composite image adapted to the stereoscopic display apparatus 11, the stereoscopic image synthesizing unit 104 refers to the stereoscopic display parameters stored in the stereoscopic display information storing unit 103. An outline of the generation of a composite image is explained with reference to FIG. 13. It is assumed that the stereoscopic video input apparatus 13 includes four cameras 2500 to 2503 with optical axes arranged horizontally as shown in FIG. 25 and the stereoscopic display apparatus 11 is a stereoscopic display apparatus of a type for performing observation via lenticular lenses in a four-view type as shown in FIG. 26. When a pixel value in a position x, y of a camera c at time t is f(t, c, x, y), pixel arrangement of a composite image is as shown in FIG. 13.

In step S403, the stereoscopic image synthesizing unit 104 transfers the composite image synthesized in step S402 to the stereoscopic display apparatus 11 and displays a stereoscopic video on the stereoscopic display apparatus 11. Note that, although the stereoscopic video inputted from the stereoscopic video input apparatus 13 is displayed in the processing in FIG. 4, it is also possible to process the stereoscopic video file saved in the storing unit 101 in FIG. 1 in the same manner. However, when the stereoscopic video file saved in the storing unit 101 is used, the temporary storage unit 100 does not have to be used.

Referring back to FIG. 3, in step S301, the stereoscopic video printing system judges whether there is a stereoscopic printing request from a user. If there is no stereoscopic printing request, the stereoscopic video printing system shifts to step S300 and displays a stereoscopic video at the next time. On the other hand, if there is a stereoscopic printing request, the stereoscopic video printing system shifts to step S302. In step S302, the stereoscopic video printing system sets the apparatus in a stereoscopic moving image reproduction and print mode. In this mode, as explained above, the stereoscopic video storing system for storing a stereoscopic video in the temporary storage unit 100 is changed. Thus, a new stereoscopic video is not stored in the temporary storage unit 100. Consequently, it is possible to perform stereoscopic print using stereoscopic videos in the predetermined period until time when the user requests the stereoscopic print.

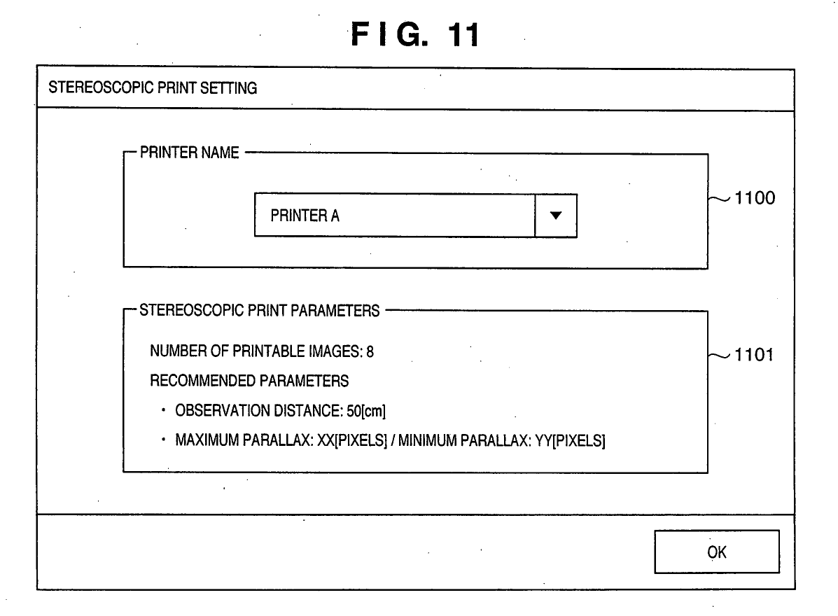

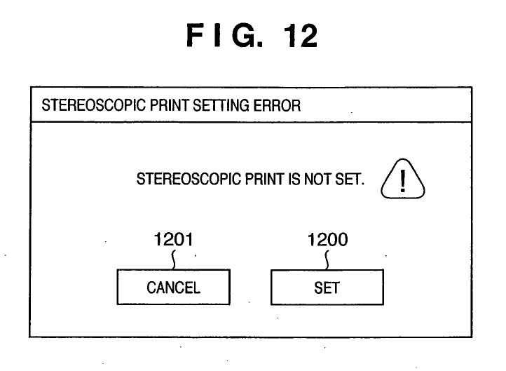

The stereoscopic video printing system shifts to step S303 and checks whether the stereoscopic printing apparatus 12 is set. If the stereoscopic printing apparatus 12 is set, the stereoscopic video printing system displays a warning dialog shown in FIG. 12 to the user. When a “cancel” button 1201 is pressed (clicked), the stereoscopic video printing system returns to step S300 in FIG. 3 and continues display of the stereoscopic video (not shown). When a “setting” button 1200 is pressed, the stereoscopic video printing system shifts the processing to step S304 and performs setting for a stereoscopic printing apparatus. An example of a dialog for performing setting for a stereoscopic printing apparatus is shown in FIG. 11. In a list box 1100, the user can select an apparatus in which the user wishes to perform stereoscopic print from a list of connected apparatuses capable of performing stereoscopic print. Stereoscopic print parameters peculiar to the stereoscopic printing apparatus selected in the list box 1100 are displayed in an area 1101. The stereoscopic print parameters include the number of printable images, a recommended observation distance, and maximum/minimum parallax amounts among images. The stereoscopic print parameters are stored in the stereoscopic print information storing unit 107.

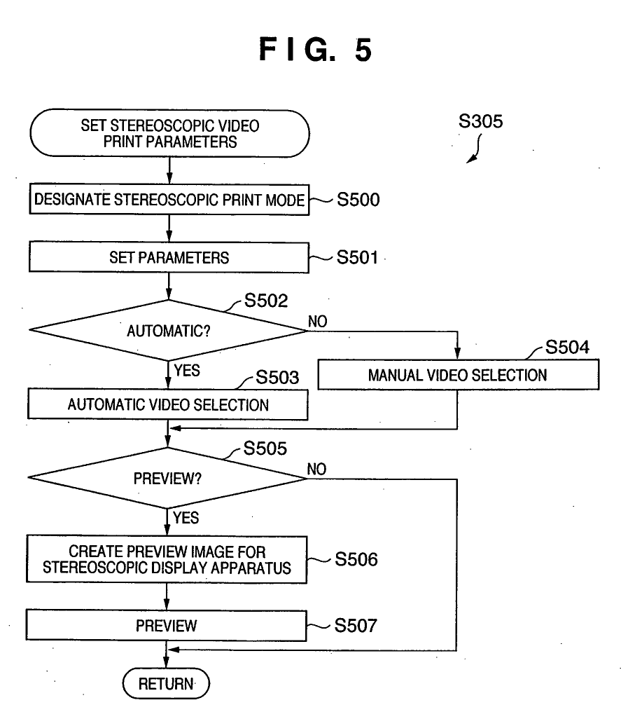

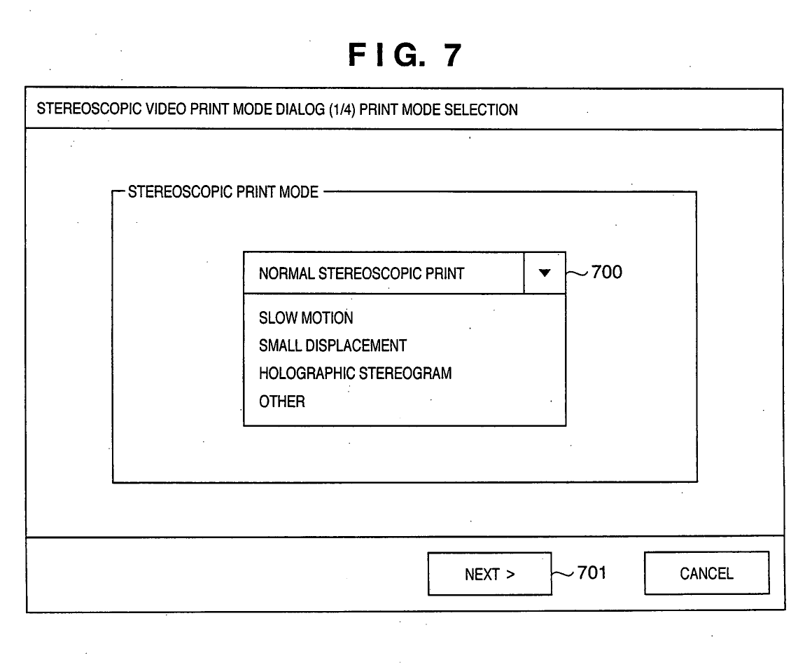

In step S305, the stereoscopic video printing system sets various parameters concerning the stereoscopic video printing and selects a frame used for the stereoscopic video printing. Contents of processing of this step are explained in detail with reference to a flowchart in FIG. 5. First, in step S500, the stereoscopic video printing system designates a stereoscopic print mode, that is, how a stereoscopic video is printed in the stereoscopic printing apparatus 12. An example of a dialog for setting the stereoscopic video printing is shown in FIG. 7. In FIG. 7, the user selects how the stereoscopic print is performed (a stereoscopic print mode) using a list box 700. After a stereoscopic print mode is selected, when a “next” button 701 is pressed, the stereoscopic video printing system sets parameters incidental to the stereoscopic print mode selected. In this embodiment, it is possible to select a stereoscopic print mode from four types of modes, “normal stereoscopic print”, “slow motion”, “small displacement”, and “holographic stereogram”.

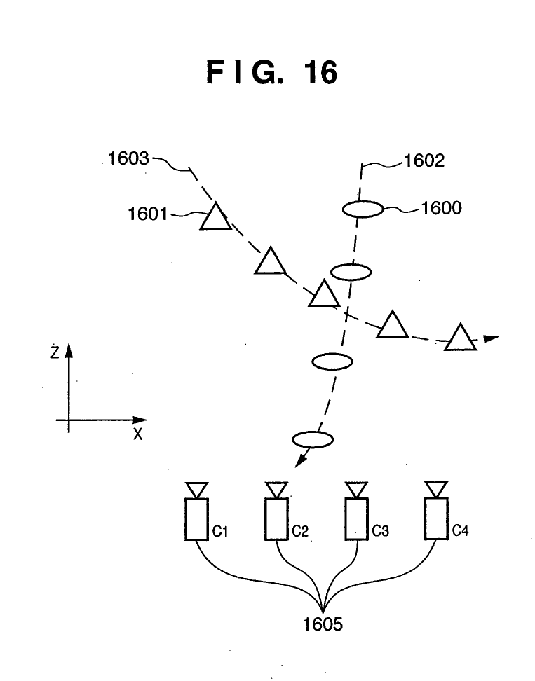

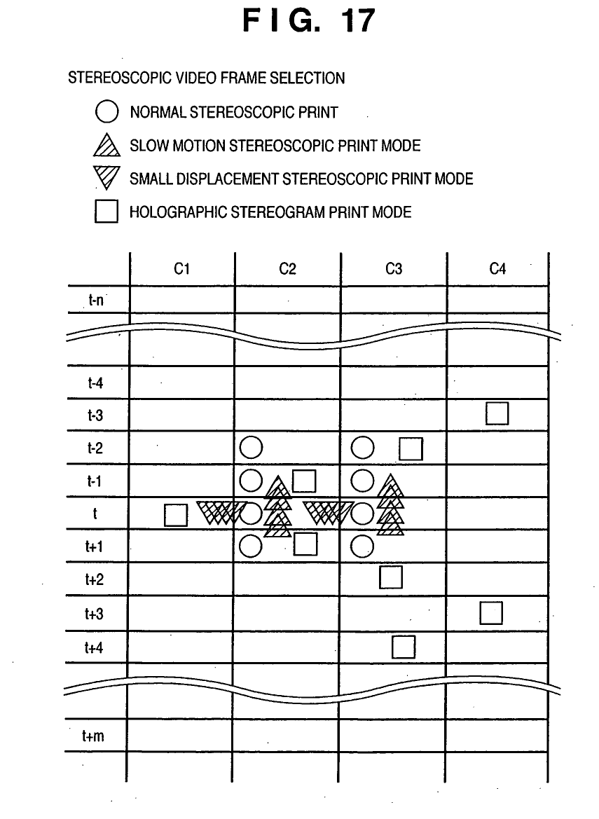

The respective kinds of the stereoscopic print mode are explained in detail with reference to FIGS. 16 and 17. A print mode is a variation for obtaining stereoscopic video printing having various effects by considering, in selecting a frame that should be printed from a stereoscopic image, what time a frame is printed, a frame of which camera is printed, and the like. FIG. 16 is a conceptual diagram of imaging using the stereoscopic video input apparatus 11 assumed in this embodiment viewed from above. In a imaging space, objects 1600 and 1601 are approaching a stereoscopic video input apparatus 1605 along loci 1602 and 1603, respectively. It is assumed that moving velocities of the objects 1600 and 1601 are different.

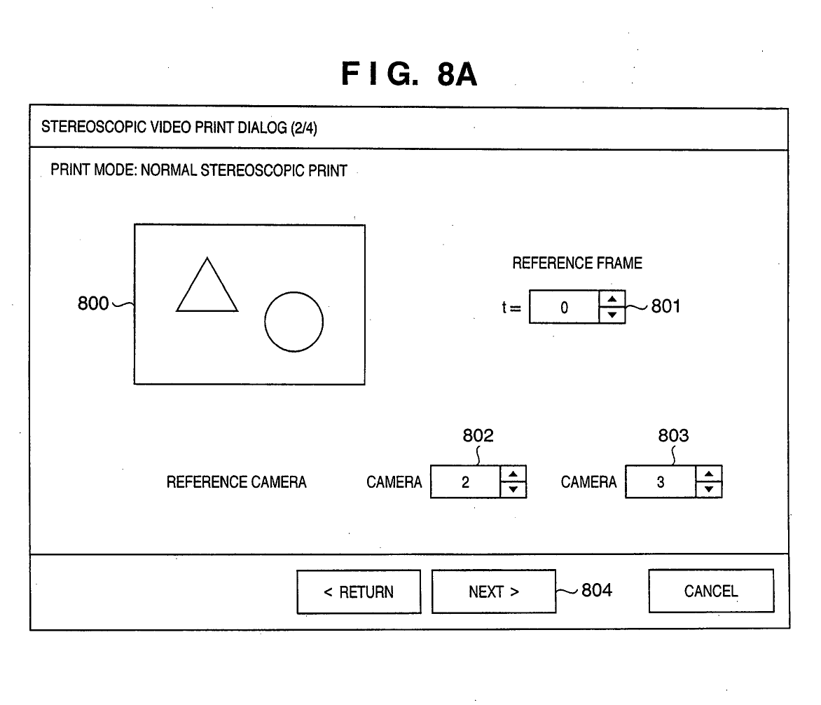

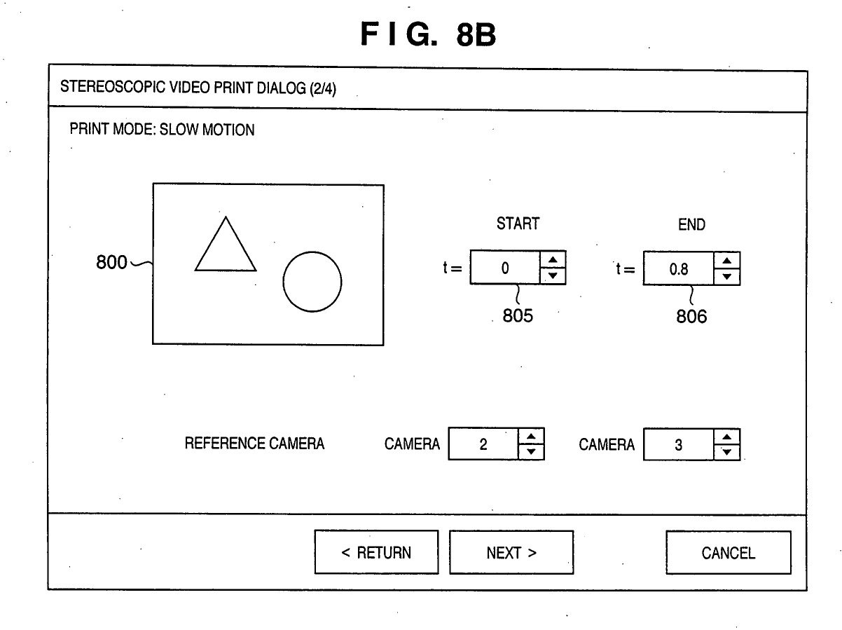

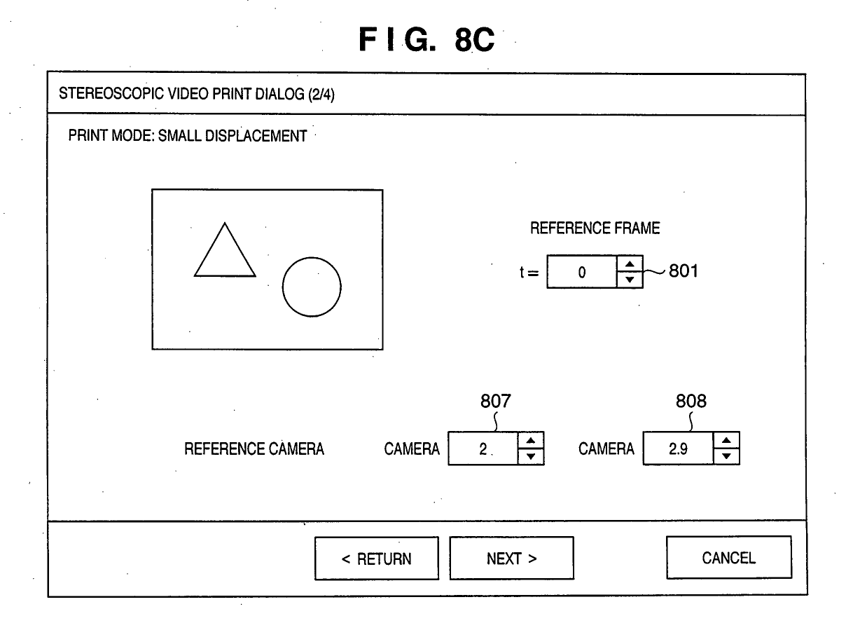

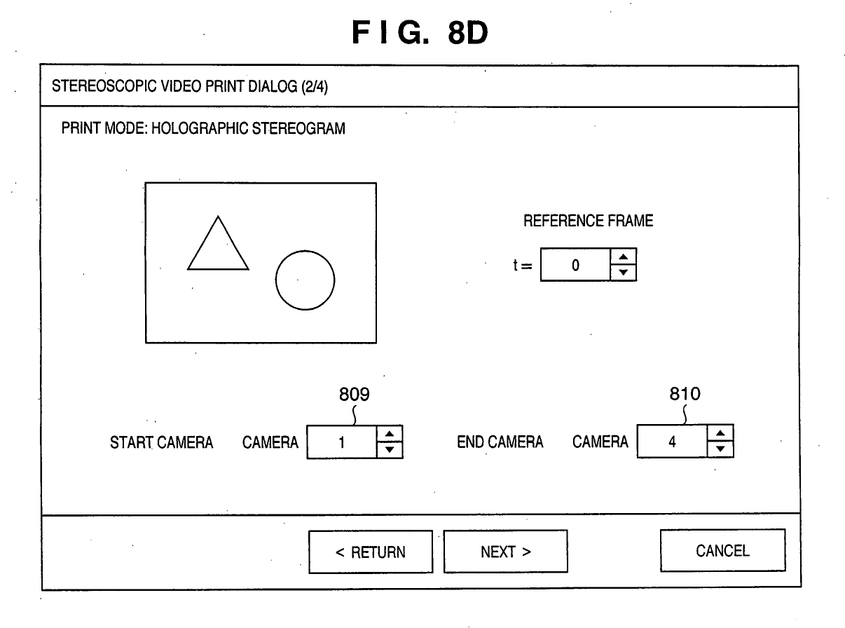

FIG. 17 is a table conceptually representing how a video (a frame) is selected according to a stereoscopic print model. An ordinate indicates imaging time (t) and an abscissa indicates the respective cameras (C1 to C4) of the stereoscopic video input apparatus 11. There are various selection methods for a video such as “normal stereoscopic print”, “slow motion stereoscopic print”, “small displacement stereoscopic print”, and “holographic stereogram print” according to the respective stereoscopic print modes. Combinations of video selection in the respective print mode are explained below with reference to FIG. 17. Examples of parameter designation dialogs in the respective print modes are explained with reference to FIGS. 8A to 8C. For simplicity of explanation, it is assumed that a constitution for stereoscopic observation is an optical system including lenticular lenses of an eight-view type and the stereoscopic printing apparatus 12 forms a stereoscopic image corresponding to such an observation system.

[Normal Stereoscopic Print Mode]

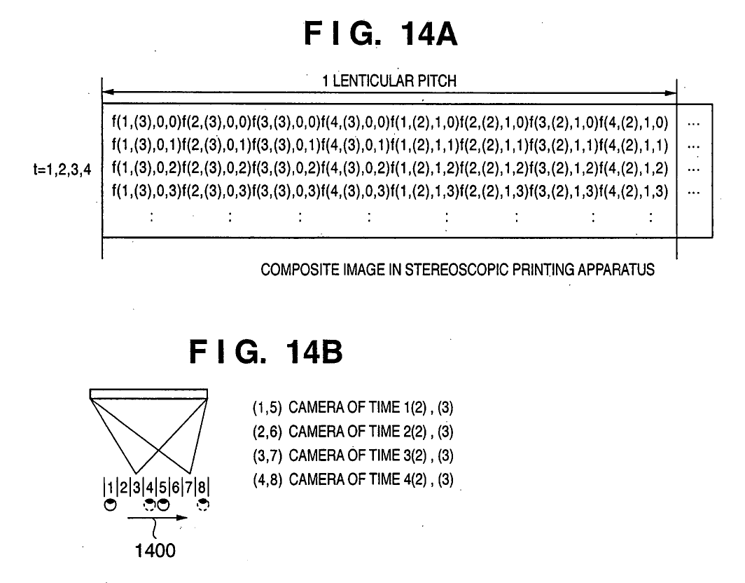

This mode is realized by selecting videos at identical time of a predetermined camera pair as indicated by “∘” in FIG. 17. In this case, it is possible to observe videos of an identical camera pair in a time axis direction and stereoscopically by observing a result of stereoscopic print while changing a view position as shown in FIG. 14. An example of a parameter setting dialog displayed in the parameter setting in step S501 is shown in FIG. 8A. The dialog in FIG. 8A is displayed by selecting normal stereoscopic print in the list box 700 of the dialog in FIG. 7. In FIG. 8A, reference numeral 801 denotes imaging time t of a frame that should be set as a reference frame (a top frame used for the normal stereoscopic print); 802, a reference camera; and 803, a setting box for designating a camera adjacent to the reference camera. A video of a frame of a reference camera selected in the box 802 at time t designated in the box 801 is displayed in a window 800. It is possible to select video frames indicated by “∘” in FIG. 17 and execute the normal stereoscopic print by setting parameters according to such an example of a dialog. Note that the number of frames to be selected is one half of the number of views that can be displayed in the stereoscopic printing apparatus.

[Slow Motion Stereoscopic Print Mode]

In the slow motion stereoscopic print mode, in selecting videos at identical time of predetermined cameras as indicated by “▴” in FIG. 17, a video with a smaller interval than a time interval of an actual stereoscopic video is generated by image processing and a composite image is generated from the video generated. Consequently, it is possible to create a composite image having an effect of a stereoscopic video that moves in slow motion in appearance. It is possible to generate a video with a smaller interval than a time interval of a stereoscopic video by using a publicly-known morphing technique. See, for example, “Feature-Based Image Metamorphosis,” Computer Graphics Proc. Vol. 29, pp. 35-42, (1992) and “Interpolation between images based on projection conversion” (the Institute of Electronics, Information and Communication Engineers, Technical Report IE94-14 (1994-05), pp. 29-36).

An example of a parameter setting dialog displayed in step S501 when the slow motion stereoscopic print mode is designated in step S500 is shown in FIG. 8B. The dialog in FIG. 8B is displayed by selecting “slow motion” in the list box 700 of the dialog in FIG. 7. The dialog in FIG. 8B is different from the dialog in FIG. 8A in that time of a start frame (805) and time of an end frame (806) are set as time of a frame to be selected. In particular, it is possible to continuously designate the time of the end frame as shown in FIG. 8B (in this embodiment, it is possible to designate the time down to the first decimal place) compared with the time of the start frame. Note that the start frame may be continuously designated like the end frame. When the number of frames present in a period designated by the time of the start frame and the time of the end frame exceeds the number of frames that can be stereoscopically printed, time may be set at intervals more equal than the designated period and a GUI for allowing a user to set the intervals may be added. For example, in a display apparatus of the four-view type, when the start frame is set to 0 and the end frame is set to 0.8 at intervals of 0.1, eight frames are selected but the display apparatus does not have display for eight-views. In such a case, it is possible to create a video having an effect like slow motion in appearance by selecting four frames, for example, 0, 0.2, 0.4, 0.6, and 0.8. Although a frame interval for selection is fixed at 0.2 in the example described above, a user may designate an interval. When the user sets an interval in this way, if there is no video that just matches the interval, it is possible to perform stereoscopic print by generating a video using the morphing technique or the like. It is possible to select video frames indicated by “▴” in FIG. 17 and execute slow motion stereoscopic print by setting parameters according to the dialog shown in FIG. 8B.

[Small Displacement Stereoscopic Print Mode]

In the small displacement stereoscopic print mode, as indicated by “▾” in FIG. 17, it is possible to create a video having an effect due to small displacement of a view position by generating a video in a camera position where a camera is not present and performing stereoscopic print using the video. The small displacement stereoscopic print mode is the same as the slow motion stereoscopic print mode in that a new video is generated by image processing. However, the small displacement stereoscopic print mode does not make a time interval variable. Note that, concerning a imaging position where a camera is not present, it is possible to designate not only the example in the figure but also combinations in various positions among the cameras C1 to C4. For such video generation in a imaging position where a camera is not present, for example, it is possible to use an arbitrary view position image generation technique described in Japanese Patent Application Laid-open No. 2001-346226 proposed by the applicant. In this case, it is possible to generate a high-quality arbitrary view position image (generate a video like a video imaged from a position other than a camera position where a camera is placed on the basis of a video imaged from the camera position described above) by using all camera videos at identical time. Since small displacement is performed, it is likely that parallax is insufficient and a stereoscopic sense is insufficient even if the video generated is directly observed. However, even in such a case, it is possible to generate a video having an appropriate stereoscopic sense by converting a parallax amount described in the proposal into a form suitable for the stereoscopic printing apparatus.

An example of a parameter setting dialog displayed in step S501 when the small displacement stereoscopic print mode is designated in step S500 is shown in FIG. 8C. The dialog in FIG. 8C is displayed by selecting “small displacement” in the list box 700 of the dialog in FIG. 7. The example of the dialog in FIG. 8C is different from that in FIG. 8B in that the part of frame designation (801) is the same as that in FIG. 8A and it is possible to continuously select camera positions corresponding to a reference camera and a camera adjacent to the reference camera. Note that, in this embodiment, it is possible to designate a value down to the first decimal place as a numerical value indicating a camera position. It is possible to set parameters of the small displacement stereoscopic print according to such a dialog. It is possible to select video frames indicated by “▾” in FIG. 17 and execute the small displacement stereoscopic print by setting such parameters.

[Holographic Stereogram Print Mode]

The holographic stereogram print mode is a print mode for forming a stereoscopic image having an effect like a holographic stereogram by, as indicated by “□” in FIG. 17, selecting images with sequentially moving times and camera positions and generating a composite image. In FIG. 17, actual camera videos are selected as all the images. However, it is also possible to use videos generated at time when and in camera positions where an actual imaged image is not present as in the slow motion stereoscopic print mode and the small displacement stereoscopic print mode.

An example of a parameter setting dialog displayed in step S501 when the holographic stereogram print mode is designated in step S500 is shown in FIG. 8D. The dialog in FIG. 8D is displayed by selecting “holographic stereogram” in the list box 700 of the dialog in FIG. 7. The user select a reference frame to be a top frame as in the FIG. 8A in the list box 801, designates a camera that starts video selection in a list box 809, and designates a camera that ends the video selection in a list box 810. According to the setting described above, videos are selected as indicated by “□” in FIG. 17 from the camera designated in the list box 809 at time of the top frame designated in the reference frame 801 to the camera designated in the list box 810. In this way, it is possible to set parameters of the holographic stereogram print mode. The holographic stereogram print mode has been explained.

As described above, the stereoscopic video printing system performs parameter setting corresponding to the respective stereoscopic print mode and shifts to step S502.

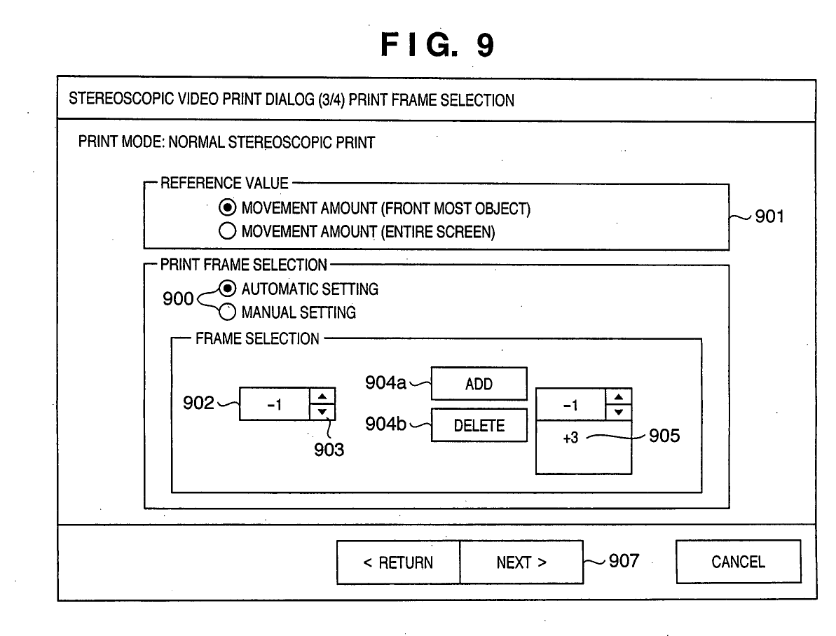

Referring back to FIG. 5, in step S502, the stereoscopic video printing system determines which frame is set as an object of stereoscopic print with respect to reference time set by the dialogs corresponding to the respective stereoscopic print mode. As a method of the determination, there is a method of automatically determining a frame and a method of manually determining a frame. In automatically determining a frame, the stereoscopic video printing system shifts to step S503 and automatically selects time to be a stereoscopic print object. In manually selecting a frame, the stereoscopic video printing system shifts to step S504 and manually selects time to be a stereoscopic print object. An example of a dialogue for performing the setting described above is shown in FIG. 9.

In FIG. 9, reference numeral 900 denotes radio buttons for selecting, with set reference time as a reference, whether video time to be a stereoscopic print object other than the reference time is automatically set or manually set. When automatic setting is selected by the radio buttons 900, it is impossible to select an area indicated as “frame selection”. When manual setting is selected, it is possible to select the area indicated as “frame selection”. When the automatic setting is selected, it is possible to select a reference for automatically setting frame selection described later using a reference setting section 901. On the other hand, when the manual setting is selected, the user changes time 902 displayed in a frame selection section using an increase/decrease button 903 to select desired time (time of a stereoscopic print object). When the user presses an addition button 904a, the desired time is added to a selection list 905. When the user selects time displayed in the selection list 905 and presses a deletion button 904b, the time selected is deleted. In this way, it is possible to edit registered time. When a predetermined number of frames determined according to the stereoscopic printing apparatus 12 are registered in the selection list 905, it is possible to select a “next” button 907 and the stereoscopic video printing system can shift to step S505. Note that, as the time 902 is increased or decreased, a frame image corresponding to the time may be displayed.

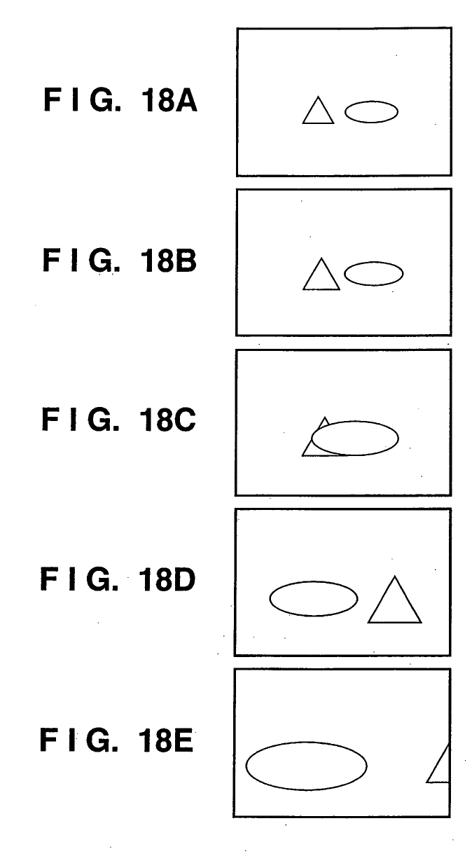

The automatic selection method in step S503 is explained with reference to FIG. 17 and FIGS. 18A to 18E. FIGS. 18A to 18E are diagrams of videos of continuous time acquired from the camera C2 that images a scene in FIG. 16. Times of imaging are t−2, t−1, t, t+1, and t+2 in the table in FIG. 17. Videos in FIGS. 18A and 18B have a very small amount of motion in appearance because a subject distance is long. However, there is movement among videos in FIGS. 18B to 18E. In this way, if videos at continuous times are simply used as they are, videos with less movement as in FIGS. 18A and 18B are selected, resulting in no movement as stereoscopic video print. In such a case, in the table in FIG. 17, as stereoscopic video print, it is preferable to select videos having movement to some extent by selecting temporally discontinuous videos such as selecting a video at time t−2 and then selecting a video at time t. Conversely, concerning FIGS. 18C and 18D and FIGS. 18D and 18E, it is also likely that a moving amount of an object is too large and the movement cannot be observed as a smooth motion. In such a case, in the table in FIG. 17, smoother stereoscopic video print is possible when videos at times t, t+0.5, and t+1 are generated and selected. A video at time t+0.5 is generated by the method (e.g., morphing) explained in the slow motion stereoscopic print mode.

In step S503, as described above in the explanation of the small displacement stereoscopic print mode, it is also possible to designate a video in a imaging position where a camera is not present.

As explained above, as an effect of stereoscopic print, it is desirable that videos having a temporally satisfactory movement and a change in a depth sense can be selected easily. Thus, in step S503, the stereoscopic video printing system automatically detects movement (including movement in a depth direction) between videos to select a video. As a method of detecting movement between videos, it is conceivable to use a simple inter-image difference of videos between continuous times of a reference camera and a motion vector utilizing template matching and optical flow detection. Concerning movement in the depth direction, it is possible to calculate parallax/distance from a result of corresponding point extraction according to template matching between videos at identical time between the reference camera and a camera adjacent to the reference camera. As both the references, an average value of values of an entire image may be used or a value of only an area near a screen where a main subject is present may be used.

The stereoscopic video printing system performs image formation in step S306/step S506 described later utilizing a reference value set in the reference value setting unit 901 in FIG. 9 using movement information of videos calculated in this way. When an “amount of movement (a front most object)” is selected in the reference value setting unit 901, the stereoscopic video printing system shifts parallax to the left and the right every time to adjust the parallax such that an object present in the forefront in the movement information looks closest to a viewer side when stereoscopic print is performed. Note that it is possible to realize the judgment on a front most object with a publicly-known technique. For example, it is possible to realize the judgment on a front most object using a size of a motion vector or estimating depth in stereo image measurement or the like. When an “amount of movement (of an entire screen)” is designated in the reference value setting unit 901, image formation is performed to associate movement information held by all videos at respective times with a stereoscopic display range in which stereoscopic print is possible. By using such a reference value, it is possible to more clearly designate an effect at the time when stereoscopic print is performed.

As explained above, as an effect of stereoscopic print, it is desirable that videos with temporally satisfactory movement and a change in a depth sense can be selected easily. Thus, in step S503, the stereoscopic video printing system automatically detects movement between videos to select a video. For example, in the normal stereoscopic print mode, the stereoscopic video printing system selects a video that should be printed with a reference frame designated by the user interface in FIG. 8A as a top frame. As a method of detecting movement between videos, it is conceivable to use a reference utilizing a simple inter-image difference of videos between continuous times of a reference camera or a motion vector utilizing template matching or optical flow detection. As movement in the depth direction, it is possible to calculate parallax/distance from a result of corresponding point extraction according to template matching between videos at identical time between the reference camera and a camera adjacent to the reference camera. As both the references, an average value of values of an entire image may be used or a value of only an area near a screen where a main subject is present may be used.

In detecting temporal/spatial movement described above, since stereoscopic videos stored in the temporary storage unit 100 are infinite, the stereoscopic video printing system performs search in the range and determines a video to be a print object. Similarly, concerning stereoscopic videos saved as a file in the storing unit 101, the stereoscopic video printing system searches for a video to be a print object in the file. On the other hand, in step S504, the stereoscopic video printing system manually selects a video as described above.

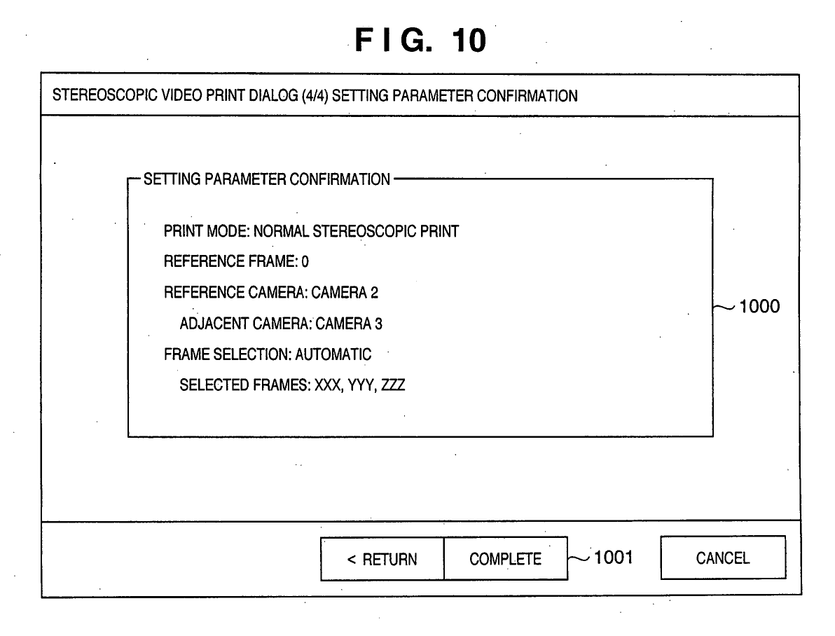

According to the operations described above, a video to be stereoscopically printed is selected in step S503 or S504 and display shown in FIG. 10 is presented to the user as an example of a confirmation dialog.

In step S505 in FIG. 5, the stereoscopic video printing system inquires of the user whether the user previews, with the stereoscopic printing apparatus 11, a state at the time when stereoscopic print is performed with the stereoscopic print parameters set. When the user previews the state, the stereoscopic video printing system proceeds to step S506, generates a video for preview on the basis of the stereoscopic print parameters, and displays the video on the stereoscopic display apparatus 11 in step S507. On the other hand, when the user does not preview the state, the stereoscopic video printing system ends the flowchart and shifts to step S306 of the flowchart in FIG. 3.

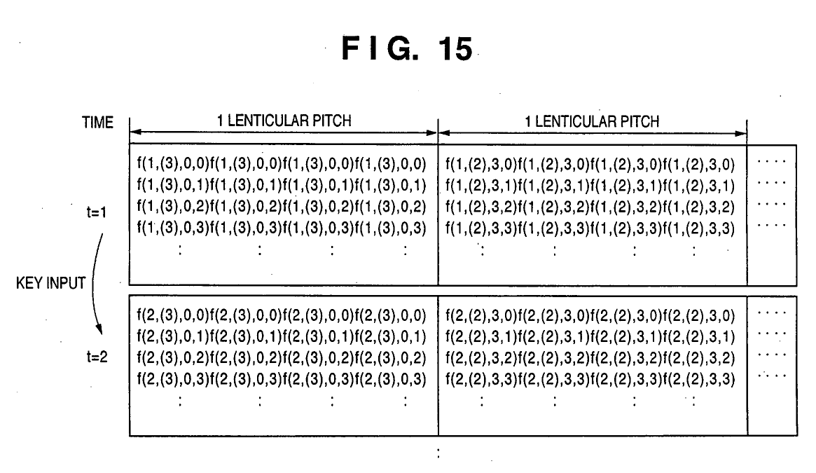

A specific composite image for previewing, in the stereoscopic display apparatus 11, contents of stereoscopic print in the stereoscopic printing apparatus 12 is explained with reference to FIG. 15. In performing preview, as shown in FIG. 14, the same view position movement as at the time of observation of stereoscopic print result is performed only when the number of views of the stereoscopic display apparatus 11 and the number of views of the stereoscopic printing apparatus 12 are identical. Therefore, in the preview in this embodiment, a preview function is attained by stereoscopic videos for which a frame to be displayed is switched for every input event (e.g., specific key input from a keyboard and a click operation of a mouse) from the user to the input apparatus. A pixel arrangement of a composite image displayed on the stereoscopic display apparatus 11 is shown in FIG. 15. Since the stereoscopic display apparatus 11 is the stereoscopic display apparatus of the four-view type, by arranging an image pair to be stereoscopically viewed as shown in the figure, it is possible to observe the image pair as a normal two-view stereoscopic video. In this case, since a stereoscopic sense is different in the case in which an actual result of stereoscopic print is observed and in the case in which a stereoscopic video is previewed by the stereoscopic display apparatus 11, a parallax amount may be adjusted to adjust the stereoscopic sense. Specifically, it is possible to realize the adjustment of a parallax amount by translating an image in a left to right direction. Alternatively, the stereoscopic video printing system may cause the user to input the parallax amount and an adjustment amount. When the user observes the stereoscopic video with preview screens sequentially changed and judges that a desired effect of stereoscopic print is not obtained, the stereoscopic video printing system returns to step S500 and performs the setting for stereoscopic print parameters again. When the user judges that a result of preview is satisfactory, the stereoscopic video printing system ends the flowchart and proceeds to step S306 in FIG. 3.

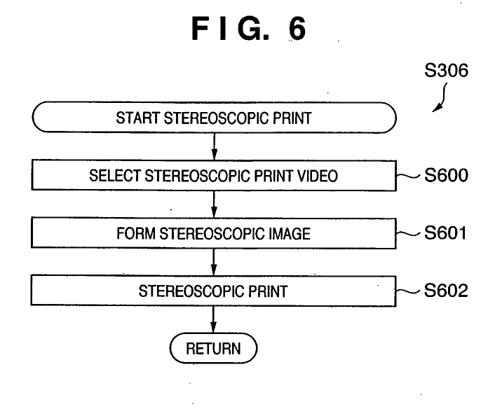

Referring back to FIG. 3, in step S306, the stereoscopic video printing system performs stereoscopic print using the stereoscopic print parameters determined in step S305. A flow of the processing is explained with reference to a flowchart in FIG. 6.

First, in step S600, the stereoscopic video printing system selects the video (the frame) selected in step S305 with the video selecting unit 106. In step S601, the stereoscopic video printing system generates a composite image for the stereoscopic printing apparatus 12 on the basis of the video selected in step S600 and the stereoscopic print parameters stored in the stereoscopic print information storing unit 107. In step S602, the stereoscopic video printing system transfers the composite image generated to the stereoscopic printing apparatus 12 and returns to step S307. In this case, it is possible to perform more attractive stereoscopic print by converting a parallax amount of an image to be stereoscopically printed into maximum/minimum parallax amounts that are information peculiar to the stereoscopic printing apparatus 12. Since it is preferable that a projecting/sinking amount is consistent in time series with respect to a result of stereoscopic print, as a parallax adjustment amount, all images subjected to the stereoscopic print are adjusted with an identical adjustment amount.

When the stereoscopic print is performed as described above, the stereoscopic video printing system shifts to step S307 and returns a storage mode of the temporary storage unit 100 to a normal storage mode for storing a stereoscopic video from the stereoscopic video input apparatus 13. In this case, a video group (predetermined selected time videos) used for the stereoscopic print or the stereoscopic videos stored in the temporary storage apparatus 100 may be compressed according to a predetermined compression system and stored in the storing unit 101.

As explained above, according to the first embodiment, it is possible to set various parameters temporally/spatially in performing stereoscopic print of a scene desired by a user while observing a stereoscopic video inputted from the stereoscopic video input apparatus 13. Consequently, there is an advantage that it is possible to easily perform stereoscopic video print having various effects. For example, it is possible to observe an image having movement by changing a view position at the time of observation. In that case, since a video having movement temporally is automatically selected, there is also an advantage that it is possible to conveniently create a stereoscopic print having a higher effect. Since contents to be printed stereoscopically are previewed in the stereoscopic display apparatus 13, there is an advantage that it is possible to confirm an effect of stereoscopic print without actually printing an image and convenience is improved.

### Second Embodiment

In a second embodiment of the invention, an example in which the stereoscopic image forming apparatus of the invention is applied to 3DCG real time animation using three-dimensional computer graphics (hereinafter referred to as 3DCG) will be explained in detail.

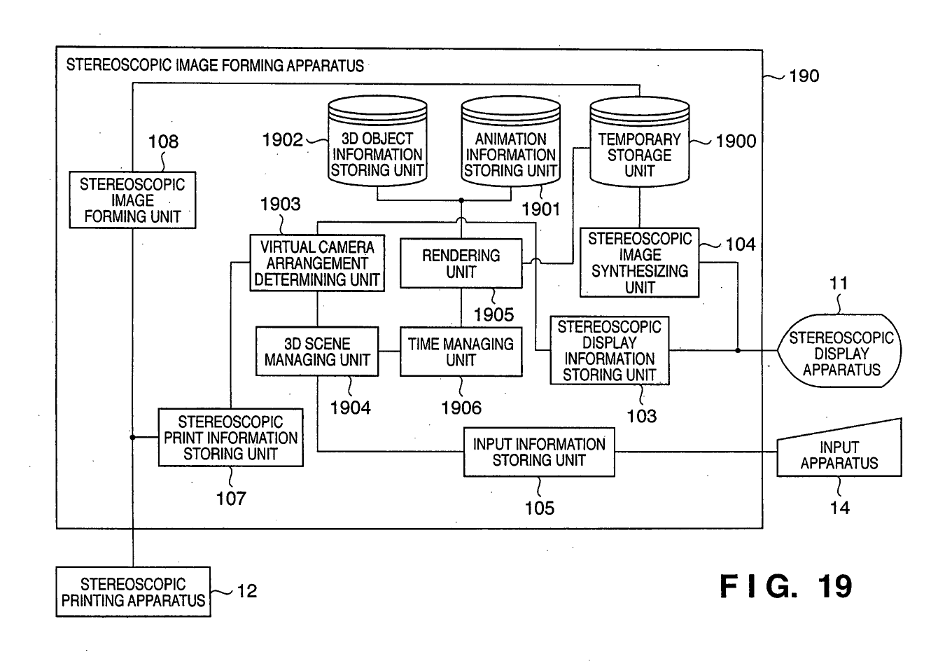

FIG. 19 is a block diagram showing a functional constitution in the second embodiment. Components denoted by the identical reference numerals in FIG. 1 perform the same operations as those in the first embodiment. Thus, detailed explanations of the components are omitted.

A stereoscopic image forming apparatus 190 is an apparatus that has plural virtual cameras arranged in a 3DCG scene and forms a composite image for displaying stereoscopic 3DCG animation generated by the plural virtual cameras on the stereoscopic display apparatus 11 and stereoscopically prints the stereoscopic 3DCG animation in the stereoscopic printing apparatus 12. An internal block constitution of the stereoscopic image forming apparatus 190 is explained.

Object data including geometrical coordinate information, surface attribute information, and texture of a 3DCG character is stored in a 3D object storing unit 1902. Animation information such as movement information of an object and camera work is stored in the animation information storing unit 1901. A 3D scene managing unit 1904 manages an entire 3D scene. A time managing unit 1906 manages time of a 3D scene for carrying out animation. A rendering unit 1905 performs rendering of a stereoscopic video of the 3D scene managed by the 3D scene managing unit 1904 and stores the stereoscopic video in a temporary storage unit 1900 in time series and for each of the virtual cameras. The stereoscopic image synthesizing unit 104 generates a composite image of a pixel arrangement corresponding to the stereoscopic display apparatus 11 according to the 3D scene stored in the temporary storage unit 1900 and causes the stereoscopic display apparatus 11 to display the composite image. A virtual camera determining unit 1903 automatically determines the number of virtual cameras and a virtual arrangement of the virtual cameras. The number of virtual cameras and the virtual arrangement of the virtual cameras are determined to be adapted to stereoscopic display parameters peculiar to the stereoscopic display apparatus 11 stored in the stereoscopic display apparatus storing unit 103 and stereoscopic print parameters peculiar to the stereoscopic printing apparatus 12 stored in the stereoscopic print information storing unit 107.

Components not explained above and denoted by the same reference numerals as those in the block diagram in FIG. 1 perform the same operations as those in the first embodiment. Since a physical constitution of the stereoscopic image forming apparatus 190 is substantially the same as that shown in FIG. 2, an explanation of the constitution is omitted.

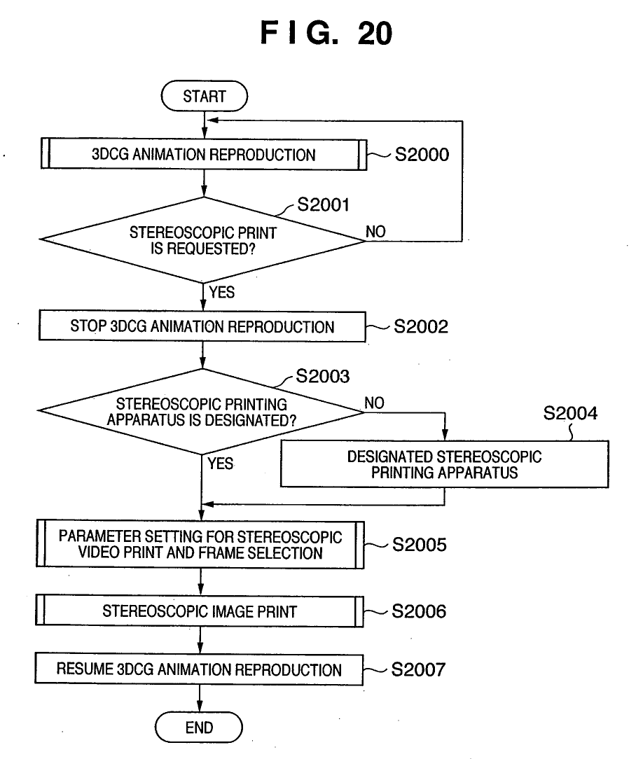

A flow of processing of the stereoscopic image forming apparatus 190 according to the second embodiment is explained in detail with reference to the flowchart shown in FIG. 20.

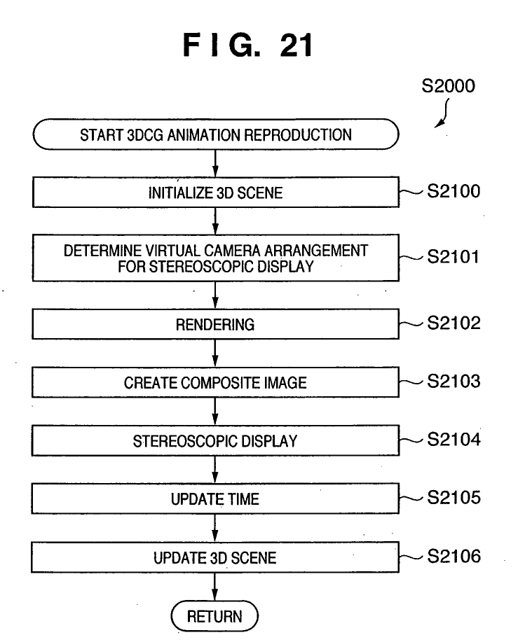

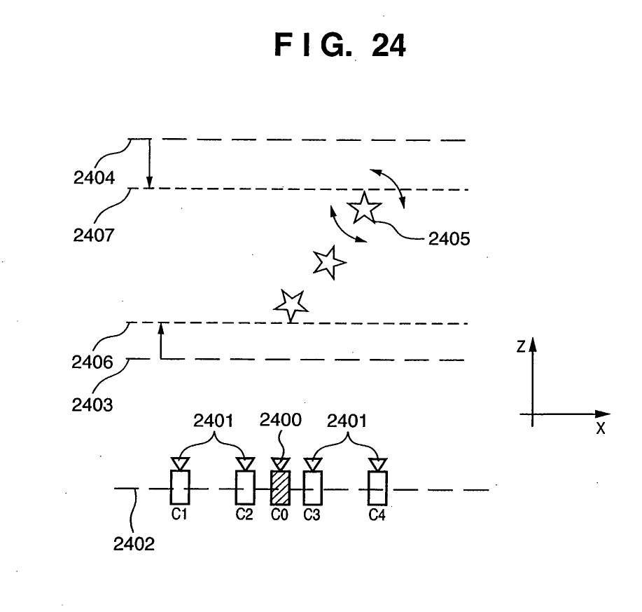

In step S2000, the stereoscopic image forming apparatus 190 performs processing for reproducing 3DCG animation. A flow of the processing is explained with reference to a flowchart in FIG. 21 and FIG. 24.

First, in step S2100, the stereoscopic image forming apparatus 190 establishes and initializes a 3D scene and arranges a 3DCG object and a virtual main camera in predetermined positions. The arrangement is schematically shown in FIG. 24. In FIG. 24, the stereoscopic image forming apparatus 190 sets a virtual main camera 2400 and arranges a 3DCG object 2405 in a predetermined position. Nearest and farthest distances are defined in 2403 and 2404 as clipping planes of the 3D scene, respectively.

In step S2101, the stereoscopic image forming apparatus 190 arranges virtual cameras for reproducing a stereoscopic moving image suitable for the stereoscopic display apparatus 11. In FIG. 24, the virtual cameras are arranged with the virtual main camera 2400 in the center. In this embodiment, as the stereoscopic display parameters stored in the stereoscopic display information storing unit 1031, it is assumed that the number of views is four and four virtual cameras 2401 are arranged. In this case, the virtual cameras 2401 are arranged with optical axes thereof set to an optical axis of the virtual main camera 2400. Base line lengths among the cameras are set to virtual camera intervals obtained by conforming maximum/minimum parallax recommended in the stereoscopic display apparatus 11 and a nearest surface 2403/a farthest surface 2404 to each other. In step S2102, the stereoscopic image forming apparatus 190 renders images from the virtual cameras set in step S2101 in the rendering unit 1906. Results of the rendering are sequentially transferred to the temporary storage unit 1900.

In step S2103, the stereoscopic image forming apparatus 190 generates a composite image to be stereoscopically displayed in the stereoscopic display apparatus 11 using the results of rendering of the respective virtual camera that are rendered in step S1202 and stored in the temporary storage unit 1900. In step S2104, the stereoscopic image forming apparatus 190 transfers the composite image generated in step S2103 to the stereoscopic display apparatus 11 to perform stereoscopic display. In step S2105, the stereoscopic image forming apparatus 190 updates time of the time managing unit 1906. In step S2106, the stereoscopic image forming apparatus 190 updates the 3D scene on the basis of the animation data stored in the animation information storing unit 1901. At this point, the virtual cameras for stereoscopic display arranged in step S2101 perform an operation following the virtual main cameral 2400.

After ending the processing in steps S2100 to S2106, the stereoscopic image forming apparatus 190 returns to step S2001 of the flowchart in FIG. 20. Thereafter, when time reaches the time of the time managing unit 1906, the processing described in FIG. 21 is executed again. Note that the user may designate a position of the virtual main camera and an update unit of the time of the time managing unit 1906. In this way, in step S2000, videos for each update time from positions of the virtual cameras set from a set position of the virtual main camera are rendered.

The operation in step S2001 is the same as the operation in step S301 in FIG. 3 in the first embodiment. When a print request is received, the stereoscopic image forming apparatus 190 shifts to step S2002 and stops update of the time of the time managing unit 1906 to thereby stop reproduction of 3D animation. In steps S2003 and S2004, the stereoscopic image forming apparatus 190 checks whether a stereoscopic printing apparatus is designated. An operation in steps S2003 and S2004 and a dialog presented to the user are the same as those in steps S303 and S304 in the first embodiment.

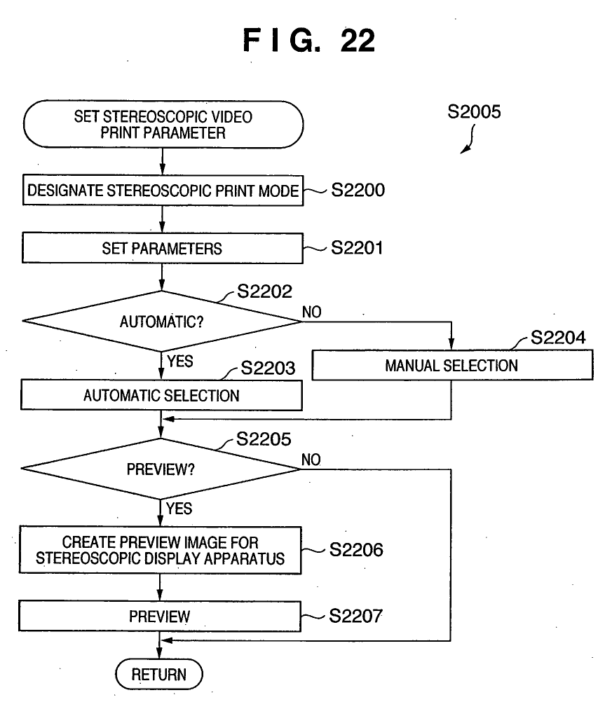

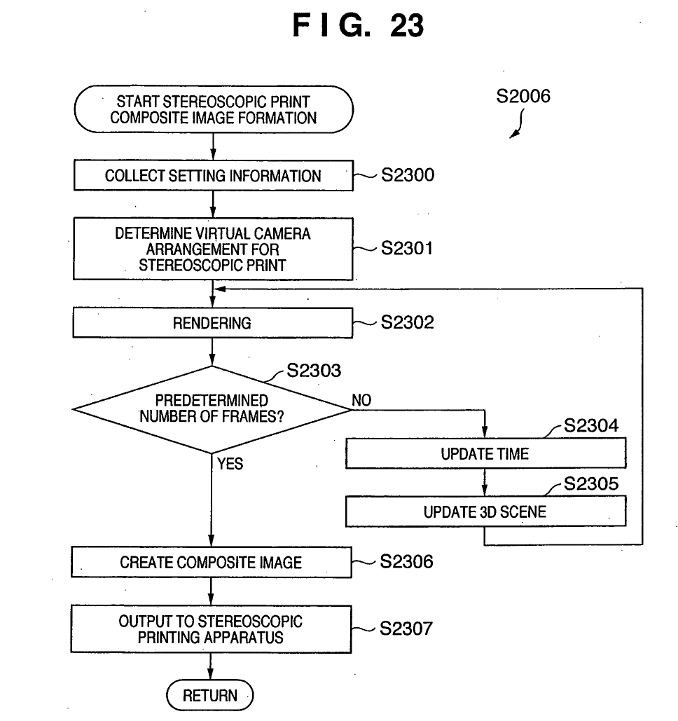

In step S2005, the stereoscopic image forming apparatus 190 performs parameter setting for stereoscopic video print and selection of a frame. This is explained with reference to a flowchart in FIG. 22. Since steps S2200, S2202, and S2205 to S2207 in the flowchart are the same as steps S500, S502, and S505 to S507 in FIG. 5, explanations of the steps are omitted. Steps S2201, S2203, and S2204 are explained below.

In step S2201, the stereoscopic image forming apparatus 190 sets parameters in association with respective stereoscopic print modes, “normal stereoscopic print”, “slow motion stereoscopic print”, “small displacement stereoscopic print”, and “holographic stereogram print”. In the case of 3DCG animation, it is possible to arbitrarily set virtual camera intervals and a time update unit for stereoscopic print. Thus, it is possible to perform the same parameter setting as step S501 in FIG. 5 by forming and presenting such a dialog.

In step S2203, in the 3DCG animation, the stereoscopic image forming apparatus 190 specifies time with movement (time with a large changing amount). In this case, unlike the first embodiment, all of virtual camera positions, 3D objects, and movement parameters of the 3D objects, and the like in a 3D scene are known. Thus, a frame at time t+i satisfying the following condition is set as a frame of stereoscopic print.

Threshold value<MAX_obj(P_obj(t)−P_obj(t+i)) Note that MAX( ) means that an object having a maximum value is selected. A subscript obj means an object present in the 3D scene. P means a coordinate value obtained by projecting world coordinates in the center of the object on image coordinates. In other words, a motion of an object with a maximum moving amount on a rendering image among objects included in a computer graphics video is analyzed.

A changing amount between frames due to movement of view positions (virtual camera positions) may be taken into account. In particular, in the small displacement stereoscopic print mode, changing between frames due to the movement of view positions is taken into account.

Other than the judgment method described above, in coping with a case in which a position of a 3DCG object does not move but is deformed (e.g., animation of a character), a judgment criteria described below may be used. In other words, a degree of deformation of a bounding box of the 3DCG object may be set as a judgment criteria or an inter-image difference of a For example, the stereoscopic image forming apparatus 190 changes the 3D scene to further improve a stereoscopic sense by adjusting virtual camera intervals to be suitable for the stereoscopic printing apparatus 12 and, in FIG. 24, changing the nearest surface 2403/the farthest surface 2404 to 2406/2407 where objects are actually present.

In step S2302, the stereoscopic image forming apparatus 190 performs rendering for images observed from the virtual cameras set. In step S2304, the stereoscopic image forming apparatus 190 updates time. In step S2305, the stereoscopic image forming apparatus 190 updates the 3DCG scene. The stereoscopic image forming apparatus 190 performs the processing for a predetermined number of frames and stores a rendering image in the temporary storage unit 1900 every time rendering is performed (step S2303). Note that the virtual camera positions in step S2301 and the time update in step S2304 are set on the basis of the virtual camera positions and the time selected in step S2203.

In step S2303, the stereoscopic image forming apparatus 190 judges whether the predetermined number of frames have been subjected to rendering. If the rendering is finished, the stereoscopic image forming apparatus 190 shifts to step S2306 and generates a composite image. This is the same as step S601 of the flowchart in FIG. 6. Finally, in step S2307, the stereoscopic image forming apparatus 190 transfers the composite image to the stereoscopic printing apparatus 12 to thereby end the processing and returns to the flowchart in FIG. 20.

In step S2007, since the stereoscopic print ends, in order to resume reproduction of the 3DCG animation, the stereoscopic image forming apparatus 190 resumes time update of the time managing unit 1906 and ends the flowchart.

As explained above, it is possible to easily perform stereoscopic video print having various effects in stereoscopic animation of 3DCG as well. In that case, by adding an operation for, for example, automating arrangement of virtual cameras, it is possible to easily obtain a print result with a high stereoscopic sense in the stereoscopic printing apparatus 12 as well.

As described above in detail, according to the stereoscopic image forming apparatus in the first embodiment, it is possible to easily create a stereoscopic print having various effects for a stereoscopic video actually imaged. According to the stereoscopic image forming apparatus in the second embodiment, it is possible to easily create a stereoscopic print having various effects in a stereoscopic 3DCG animation video as well.

According to the embodiments described above, a preview image for confirming in advance a video selected to be used in stereoscopic print is generated and displayed. Thus, it is possible to confirm an effect of stereoscopic print before printing. Thus, there is an effect that convenience for a user is improved.

The invention is not limited to the apparatuses in the embodiments described above. The invention may be applied to a system constituted by plural apparatuses or may be applied to an apparatus consisting of one device. It goes without saying that the invention is completed by supplying a storage medium having stored therein a program code of software for realizing the functions of the embodiments to a system or an apparatus and the system or the apparatus (or a CPU or an MPU) reading out and executing the program code stored in the storage medium. In this case, the program code itself read out from the storage medium realizes the functions of the embodiments. The storage medium having stored the program code therein constitutes the invention. As the storage medium for supplying the program code, it is possible to use, for example, a flexible disk, a hard disk, an optical disk, a magneto-optical disk, a CD-ROM, a CD-R/RW, a magnetic tape, a nonvolatile memory card, or a ROM. The functions of the embodiments are not only realized by the computer executing the program code read out. It goes without saying that the invention includes a case in which an OS or the like running on the computer performs a part or all of actual processing on the basis of an instruction of the program code and the functions of the embodiments are realized by the processing.

Moreover, it goes without saying that the invention includes a case in which the program code read out from the storage medium is written in a memory provided in a function extending board inserted in the computer or a function extending unit connected to the computer and, then, a CPU or the like provided in the function extending board or the function extending unit performs processing for extended functions of the function extending board or the function extending unit to perform a part or all of actual processing on the basis of an instruction of the next program code, and the functions of the embodiments are realized by the processing.

According to the invention, it is possible to easily execute stereoscopic print using various kinds of information held by a stereoscopic video.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2004-351509 filed on Dec. 3, 2004, which is hereby incorporated by reference herein.

What is claimed is:

1. An image forming apparatus comprising:
a storing unit configured to store videos imaged by plural imaging units from plural positions different from one another;
a designating unit configured to designate a desired position and a desired imaging time;
an acquiring unit configured to acquire plural frame images with at least positions or imaging times different from one another on the basis of the desired position and the desired imaging time designated by said designating unit and the videos stored in said storing unit; and
a forming unit configured to form an image by synthesizing the plural frame images acquired by said acquiring unit such that that plural frame images can be sequentially observed as stereoscopic images in accordance with movement of an observation view position when the plural frame images are observed via a predetermined optical system.

2. The apparatus according to claim 1, further comprising a first generating configured to generate a frame image at time when the imaging unit does not actually perform imaging on the basis of the videos stored in said storing unit,
wherein said acquiring unit further includes a frame image generated by said first generating unit as objects of acquisition.

3. The apparatus according to claim 2, wherein said designating unit is capable of designating time corresponding to the frame image generated by said first generating means as the desired imaging time.

4. The apparatus according to claim 1, further comprising a second generating unit configured to generate a frame image from a position where the imaging unit is not present on the basis of the videos stored in said storing unit,
wherein said acquiring unit further includes the frame image generated by said second generating unit as objects of acquisition.

5. The apparatus according to claim 1, wherein said acquiring unit further analyzes temporal change of a frame image and determines a frame that should be acquired on the basis of a result of the analysis.

6. The apparatus according to claim 1, wherein the analysis of temporal change is performed using at least one of a difference between frame images, a motion vector between frame images, and movement in a depth direction in a frame image.

7. The apparatus according to claim 1, further comprising a preview unit configured to perform preview display of an image formed by said forming unit by switching to display frame images acquired by said acquiring unit in time series.

8. An image forming apparatus comprising:
a designating unit configured to designate a desired view position and a desired time;
a selecting unit configured to select plural view positions and times on the basis of the desired view position and the desired time designated by said designating unit and the computer graphics video;
an acquiring unit configured to render frame images of the computer graphics video corresponding to the plural view position and times selected by said selecting unit, and acquire plural frame images; and
a forming unit configured to form an image by synthesizing the plural frame images acquired by said acquiring unit such that the plural frame images can be sequentially observed as stereoscopic images in accordance with movement of an observation view position when the plural frame images are observed via a predetermined observation optical system.

9. The apparatus according to claim 8, further comprising:
a setting unit configured to set a view position and a predetermined time update interval; and
a display control unit configured to render frame images of the computer graphics video corresponding to the view position and the predetermined time update interval set by said setting unit and display the rendered frame images.

10. The apparatus according to claim 8, wherein said selecting unit analyzes a temporal change of a frame image obtained by movement of time and/or a view position from the computer graphics video and selects plural view positions and times on the basis of a result of the analysis.

11. The apparatus according to claim 10, wherein, in the analysis, motion of an object with a maximum moving amount on a rendering image among objects included in the computer graphics video is analyzed.

12. The apparatus according to claim 10, wherein, in the analysis, a changing amount of a bounding box of objects included in the computer graphics video is analyzed.

13. The apparatus according to claim 8, further comprising a preview unit configured to perform preview display of an image formed by said forming unit by switching to display frame images acquired by said acquiring unit in time series.

14. An image forming method comprising:
a storing step of storing videos imaged in plural imaging steps from plural positions different from one another in a memory;
a designating step of designating a desired position and a desired imaging time;
an acquiring step of acquiring plural frame images with at least positions or imaging times different from one another on the basis of the desired position and the desired imaging time designated in the designating step and the videos stored in the storing step; and
a forming step of forming an image by synthesizing the plural frame images acquired in the acquiring step such that that plural frame images can be sequentially observed as stereoscopic images in accordance with movement of an observation view position when the plural frame images are observed via a predetermined optical system.

15. The method according to claim 14, further comprising a first generating step of generating a frame image at time when imaging is not actually performed in the imaging step on the basis of the videos stored in the memory, wherein
in the acquiring step, a frame image generated in the first generating step is further included as an objects of acquisition.

16. The method according to claim 15, wherein, in the designating step, it is possible to designate time corresponding to the frame image generated in the first generating step as the desired imaging time.

17. The method according to claim 14, further comprising a second generating step of generating a frame image from a position where the imaging step is not present on the basis of the videos stored in the memory, wherein
in the acquiring step, the frame image generated in the second generating step is further included as objects of acquisition.

18. The method according to claim 14, wherein, in the acquiring step, temporal change of an frame image is further analyzed to determine a frame that should be acquired on the basis of a result of the analysis.

19. The method according to claim 18, wherein the analysis of temporal change is performed using at least one of a difference between frame images, a motion vector between frame images, and movement in a depth direction in a frame image.

20. The method according to claim 14, further comprising a preview step of performing preview display of an image formed in the forming step by switching to display frame images acquired in the acquiring step in time series.

21. An image forming method comprising:
a designating step of designating a desired view position and a desired time;
a selecting step of selecting plural view positions and times on the basis of the desired view position and the desired time designated in the designating step and the computer graphics video;
an acquiring step of rendering subject frame images of the computer graphics video corresponding to the plural view position and times selected in the selecting step, and acquire plural frame images; and
a forming step of forming an image by synthesizing the plural frame images acquired in the acquiring step such that the plural frame images can be sequentially observed as stereoscopic images in accordance with movement of an observation view position when the plural frame images are observed via a predetermined observation optical system.

22. The method according to claim 21, further comprising:
a setting step of setting a view position and a predetermined time update interval; and
a display control step of rendering frame images of the computer graphics video in the view position and the predetermined time update interval set in the setting step and displaying the rendered frame images.

23. The method according to claim 21, wherein, in the selecting step, a temporal change of a frame image obtained by movement of time and/or a view position from the computer graphics video is analyzed and plural view positions and times are selected on the basis of a result of the analysis.

24. The method according to claim 23, wherein, in the analysis, motion of an object with a maximum moving amount on a rendering image among objects included in the computer graphics video is analyzed.

25. The method according to claim 23, wherein, in the analysis, a changing amount of a bounding box of objects included in the computer graphics video is analyzed.

26. The method according to claim 21, further comprising a preview step of performing preview display of an image formed in the forming step by switching to display frame images acquired in the acquiring step in time series.

27. A control program for causing a computer to execute the image forming method according to claim 14.

28. A computer readable memory having stored therein the control program according to claim 27.

29. A control program for causing a computer to execute the image forming method according to claim 21.

30. A computer readable memory having stored therein the control program according to claim 29.
